(19) United States
(12) Patent Application Publication
(10) Pub. No.: US 2023/0349411 A1
(43) Pub. Date: Nov. 2, 2023

(54) Sealed Cap Nail

(71) Applicant: Caleb Davidson, Washington, MI (US)

(72) Inventor: Caleb Davidson, Washington, MI (US)

(21) Appl. No.: 18/141,648

(22) Filed: May 1, 2023

Related U.S. Application Data
(60) Provisional application No. 63/336,319, filed on Apr. 29, 2022.

(51) Int. Cl. F16B 15/02

(52) U.S. Cl. CPC F16B 15/02

(57) ABSTRACT

A sealed nail cap assembly used to attach roofing felt, house wrap, tar paper and insulation foam board. Unlike galvanized nails, a cap nail has a steel shank and a large polyethylene cap. The sealed nail cap assembly generally includes a nail, a cap, and a seal (with or without ribs). The seal is perfectly fit to fit within the cap of the seal nail cap assembly.

### CROSS REFERENCE TO RELATED APPLICATIONS

This application claims priority and benefit to Provisional Patent Application Ser. No. 63/336,319 filed Apr. 29, 2022.

### TECHNICAL FIELD

The present specification generally relates to nails and, more specifically, a nail having a seal disposed therein used as building materials.

### BACKGROUND

Cap nails are used to attach roofing felt, house wrap, tar paper and insulation foam board. Cap nails are an important type of fastener used in construction and other industries. Unlike galvanized nails, a cap nail has a steel shank and a large polyethylene cap. Cap nails are intended reduce the amount of tearing of, for example, underlayment, is exposed to wind before it's fully shingled—with just nails, the heads much more easily tear right through. These spread the load over a much larger area.

Cap nails, also known as roofing nails or underlayment nails, are a type of fastener that is commonly used in construction and other industries. They consist of a nail with a large, round plastic or metal cap attached to the head. The cap serves several purposes, including protecting the nail from damage, providing a larger surface area for the nail to grip. Cap nails are typically used to attach roofing materials, such as shingles, felt paper, or underlayment, to a roof deck or other surface. They are also used to attach insulation, housewrap, and other materials to walls and other surfaces.

However, traditional cap nails do not prevent leakage of water or other fluids.

Accordingly, there exists a need in the art to provide a nail system overcoming the aforementioned disadvantages.

### SUMMARY

Disclosed herein is a sealed nail cap assembly used to attach roofing felt, house wrap, tar paper and insulation foam board. Unlike galvanized nails, a cap nail has a steel shank and a large polyethylene cap. The sealed nail cap assembly generally includes a nail, a cap, and a seal (with or without ribs). The seal is perfectly fit to fit within the cap of the seal nail cap assembly. The present invention relates to a cap nail with a seal disposed inside of the cap. The cap nail comprises a cap having a top portion and a cylindrical wall extending downwardly from the top portion, a nail member extending from the bottom of the cap, and a seal disposed inside the inner space of the cylindrical wall. The seal is formed of a resilient and waterproof material and is shaped and sized to fit snugly inside the inner space of the cylindrical wall and to conform to the shape of the nail member.

The cap nail with a seal provides improved protection against moisture and debris entering the inner space of the cap and contacting the nail member, which can lead to corrosion, rust, or other damage to the nail and/or the underlying structure. The seal can be easily and inexpensively manufactured and installed, and can be designed to fit a wide range of cap nail sizes and shapes. The cap nail with a seal can be used in various construction applications, such as roofing, siding, and decking, and can provide long-lasting and durable protection against environmental factors.

A sealed cap nail assembly, the cap nail assembly having a nail, a cap connected to the nail, the cap having a lip and an interior, and a seal, the seal snugly fit within the interior of the cap, the seal configured to prevent unwanted leaks and/or debris.

In another embodiment, cap nail assembly includes a head portion, a shank portion, a cap portion disposed over the head portion and configured to be engaged by a fastening tool and a seal disposed between the head portion and the cap portion, the seal configured to prevent moisture and debris from penetrating through the cap portion and into the head portion. The seal may comprise a resilient material. The cap portion may include a flange portion extending downwardly from a top surface of the cap portion, and the seal is disposed between the head portion and the flange portion. The seal may be a continuous ring disposed around the head portion and between the head portion and the cap portion. In some embodiments, the seal comprises a gasket material. The cap portion may be formed of a synthetic material. The shank portion may be configured for use with wood or other building materials.

In yet another embodiment, a cap nail assembly is provided including a cap having a top portion and a cylindrical wall extending downwardly from the top portion, the cylindrical wall defining an inner space, a nail member extending from the bottom of the cap, and a seal disposed inside the inner space of the cylindrical wall, the seal being configured to prevent or reduce the ingress of water, dust, or other debris through the inner space and into contact with the nail member, the seal being formed of a resilient and waterproof material and being shaped and sized to fit snugly inside the inner space of the cylindrical wall and to conform to the shape of the nail member.

A sealed cap nail assembly, the cap nail assembly generally includes a nail, a cap connected to the nail, the cap having a lip and an interior, and a seal, the seal snugly fit within the interior of the cap, the seal configured to prevent unwanted leaks.

### BRIEF DESCRIPTION OF THE DRAWINGS

The embodiments set forth in the drawings are illustrative and exemplary in nature and not intended to limit the subject matter. The following detailed description of the illustrative embodiments can be understood when read in conjunction with the following drawings, where like structure is indicated with like reference numerals and in which:

FIG. 1 depicts a perspective view of the sealed cap nail (with ribs) according to one or more embodiments shown and described herein;

FIG. 2 depicts an alternative perspective view of the sealed cap nail (with ribs) according to one or more embodiments shown and described herein;

FIG. 3 depicts a front view of the seal with ribs according to one or more embodiments shown and described herein;

FIG. 4 depicts a side view of the cap with ribs according to one or more embodiments shown and described herein;

FIG. 5 depicts an alternative side view of the cap with ribs according to one or more embodiments shown and described herein;

FIG. 6 depicts a perspective view of the cap nail without the seal installed according to one or more embodiments shown and described herein;

FIG. 7 depicts a perspective view the seal alone according to one or more embodiments shown and described herein;

FIG. 8 depicts a perspective view of the sealed cap nail (with ribs) according to one or more embodiments shown and described herein;

FIG. 9 depicts a perspective view of the seal without ribs according to one or more embodiments shown and described herein; and

FIG. 10 depicts a perspective view of the sealed cap nail (without ribs) according to one or more embodiments shown and described herein.

### DETAILED DESCRIPTION

Disclosed herein is a sealed nail cap assembly used to attach roofing felt, house wrap, tar paper and insulation foam board. Unlike galvanized nails, a cap nail has a steel shank and a large polyethylene cap. The sealed nail cap assembly generally includes a nail, a cap, and a seal (with or without ribs). The seal is perfectly fit to fit within the cap of the seal nail cap assembly.

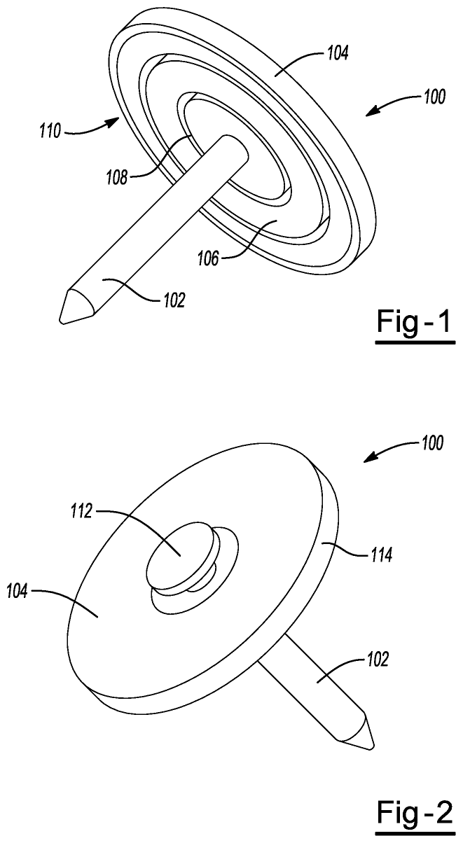

FIGS. 1 and 2 depicts a perspective view of the sealed cap nail (with ribs) according to one or more embodiments shown and described herein. A sealed nail cap assembly 100 generally includes a nail (or nail shank) 102 with a cap 104 connected thereto. A seal 106 is provided tightly and securely within the cap 104. The seal 106 may include a plurality of concentric (or non-concentric) ribs 108. The purpose of the ribs 106 a similar concept to a door seal. A door jam just doesn't have a rubber post to close against, but rather the seal gives forgiveness to the door not being perfectly flush. In this embodiment, the ribs 108 put a seal around the nail 102, and a second outer rib is a secondary seal to the washer itself. With this design, it should still be functional even if the nail 102 isn't seated perfectly.

The cap 104 includes an interior 110 and a lip 114. The seal 106 is designed to fit the exact specifications of the interior 110 of the sealed cap nail 100. A nail head 112 is exposed and rests parallel with a top surface of the cap 104. The seal 106 fits tightly and securely within the cap without having a gap between the interior of the cap and the seal.

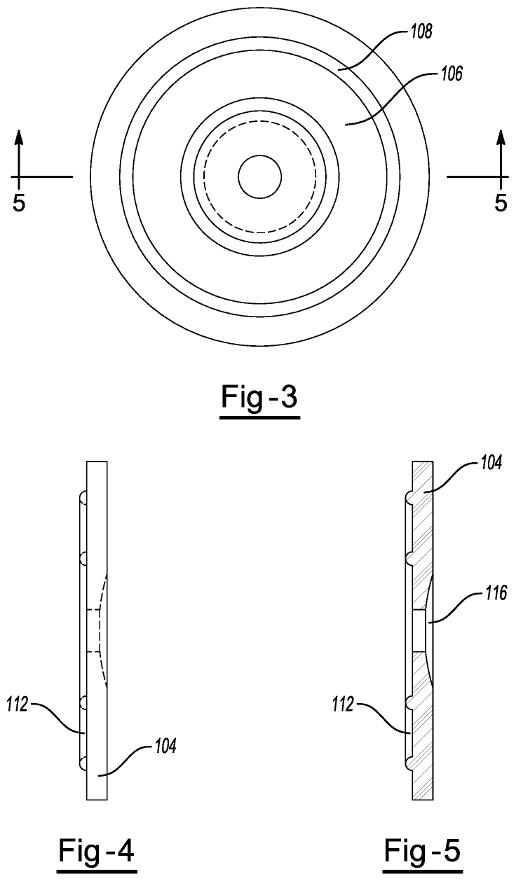

FIG. 3 depicts a front view of the seal with ribs according to one or more embodiments shown and described herein. FIG. 3 depicts the seal 106 having the plurality of concentric ribs 108. The seal 106 may have one or a plurality of ribs 108 to improve the seal. The ribs may be concentric or otherwise disposed on the surface of the seal 106 (lines, patters, dots, protrusions . . . etc.). The seal 106 is comprised of a neoprene material. In other embodiments, the seal 106 is a plastic, plastic-like, polymer, polymer-like, silicone, silicone-like, or any other suitable material having similar strength, resiliency, and sealing properties.

FIGS. 4 and 5 depict a side view of the cap with ribs according to one or more embodiments shown and described herein. A curve or cone portion 116 is shown.

The sealed nail cap 100 aids in holding power, as well as increasing sheer strength. The sealed nail cap 100 also aids in waterproofing or sealing against the elements. The synthetic material seal 106 is specifically designed for the cap 104. The seal 106 also adds rigidity to the cap 104. The seal 106 will also help eliminate shifting when properly installed. If applied to flat surfaces, the seal will aid in sealing.

The design will further include the cone 116 cut out or a grasping mechanism in the cap 104 to connect with the seal 106.

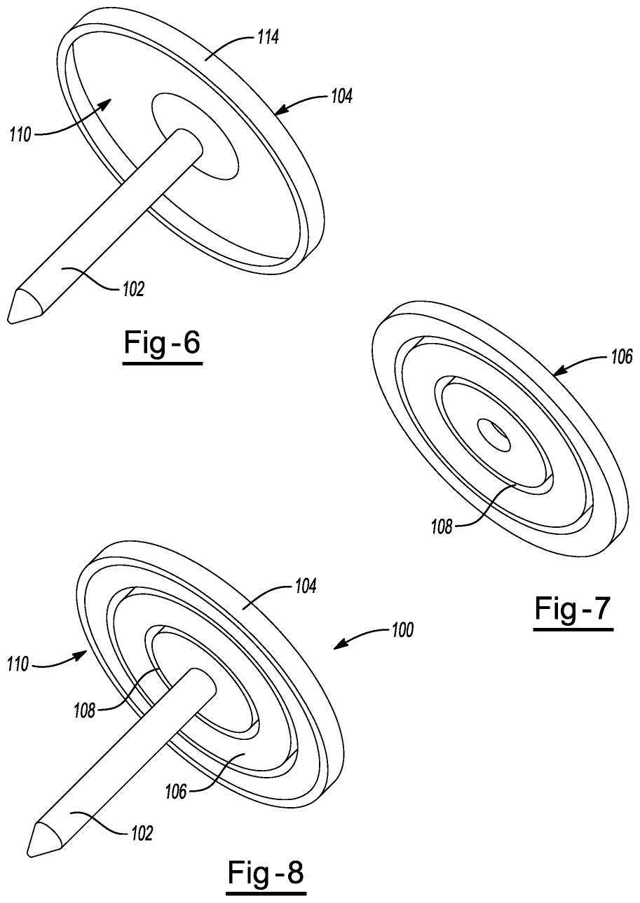

FIG. 6 depicts a perspective view of the cap nail without the seal installed according to one or more embodiments shown and described herein. FIG. 7 depicts a perspective view the seal installed according to one or more embodiments shown and described herein. FIG. 8 depicts a perspective view of the sealed cap nail (with ribs) according to one or more embodiments shown and described herein.

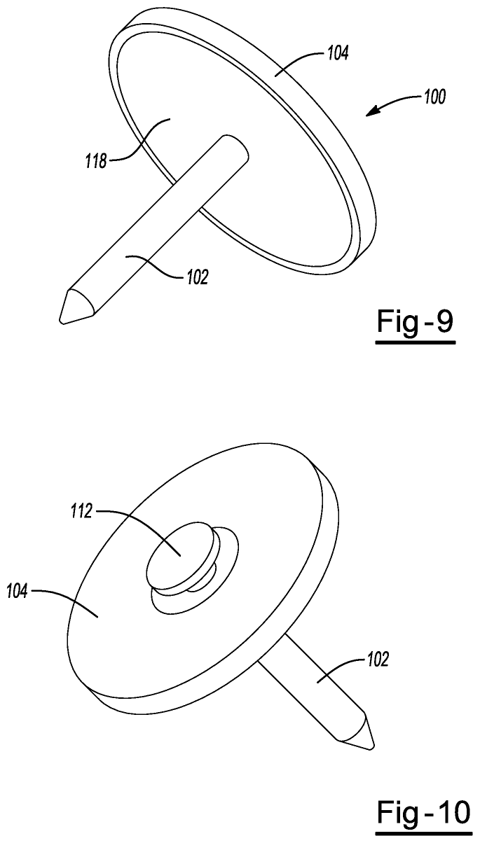

FIGS. 9-10 depict various view of seal and sealed cap assembly without ribs according to one or more embodiments shown and described herein. In this embodiment, as with prior embodiments, a sealed nail cap assembly 100 generally includes a nail (or nail shank) 102 with a cap 104 connected thereto. A seal 118 is provided tightly and securely within the cap 104 and does not include ribs.

The cap 104 includes an interior 110 and a lip 114. The seal 106 is designed to fit the exact specifications of the interior 110 of the sealed cap nail 100. A nail head 112 is exposed and rests parallel with a top surface of the cap 104.

The sealed cap nail as described herein provides the following advantages over the prior art: 1) Superior holding power: Cap nails have a larger surface area than regular nails, which means they can hold materials more securely. This is especially important in roofing applications, where wind and weather can cause materials to shift or become dislodged; 2) Improved waterproofing: The inclusion of the seal within the cap on a cap nail creates a seal around the hole created by the nail, which helps prevent water and moisture from seeping through. This is especially important in roofing applications, where water can cause serious damage if it gets into the interior of the building. 3) Reduced damage to roofing materials: The large, flat head of a cap nail distributes the force of the nail more evenly over the surface of the material being attached, which helps reduce damage to the material. This is particularly important in roofing applications, where damage to shingles or other materials can compromise the integrity of the roof; and 4) Increased safety: The cap on a cap nail makes it easier to handle and drive the nail, which can help reduce the risk of injury to the user.

The aforementioned assembly provides several advantages over prior art cap nails, including improved protection against moisture and debris entering the inner space of the cap and contacting the nail member, which can lead to corrosion, rust, or other damage to the nail and/or the underlying structure. Additionally, the seal can be easily and inexpensively manufactured and installed, and can be designed to fit a wide range of cap nail sizes and shapes.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consist of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims (and/or any future claims filed in any Utility application) cover all such changes and modifications that are within the scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter.

### ELEMENT LIST

| | |
|---|---|
| Cap nail assembly | 100 |
| Nail | 102 |
| Cap | 104 |
| Seal | 106 |
| Ribs | 108 |
| Cap interior | 110 |
| Nail head | 112 |
| Cap lip | 114 |
| Cone | 116 |
| Seal | 118 |

1. A sealed cap nail assembly, the cap nail assembly comprising:
a nail;
a cap connected to the nail, the cap having a lip and an interior; and
a seal, the seal snugly fit within the interior of the cap, the seal configured to prevent unwanted leaks and/or debris

2. A cap nail assembly comprising:
a head portion;
a shank portion;
a cap portion disposed over the head portion and configured to be engaged by a fastening tool;
a seal disposed between the head portion and the cap portion, the seal configured to prevent moisture and debris from penetrating through the cap portion and into the head portion.

3. The cap nail of claim 1, wherein the seal comprises a resilient material.

4. The cap nail of claim 1, wherein the cap portion includes a flange portion extending downwardly from a top surface of the cap portion, and the seal is disposed between the head portion and the flange portion.

5. The cap nail of claim 1, wherein the seal is a continuous ring disposed around the head portion and between the head portion and the cap portion.

6. The cap nail of claim 1, wherein the seal comprises a gasket material.

7. The cap nail of claim 1, wherein the cap portion is formed of a synthetic material.

8. The cap nail of claim 1, wherein the shank portion is configured for use with wood or other building materials.

9. A cap nail assembly comprising:
a cap having a top portion and a cylindrical wall extending downwardly from the top portion, the cylindrical wall defining an inner space;
a nail member extending from the bottom of the cap; and
a seal disposed inside the inner space of the cylindrical wall, the seal being configured to prevent or reduce the ingress of water, dust, or other debris through the inner space and into contact with the nail member, the seal being formed of a resilient and waterproof material and being shaped and sized to fit snugly inside the inner space of the cylindrical wall and to conform to the shape of the nail member.
